(19) United States
(12) Patent Application Publication
(10) Pub. No.: US 2025/0157147 A1
(43) Pub. Date: May 15, 2025

(54) ATLASED COVERAGE MESH FOR THREE-DIMENSIONAL RENDERING

(71) Applicant: Apple Inc., Cupertino, CA (US)

(72) Inventors: Michael STECKLEIN, Georgetown, TX (US); Afshin TAGHAVI NASRABADI, Los Gatos, CA (US); Maneli NOORKAMI, Menlo Park, CA (US)

(21) Appl. No.: 18/438,392

(22) Filed: Feb. 9, 2024

Related U.S. Application Data
(60) Provisional application No. 63/597,677, filed on Nov. 9, 2023.

(51) Int. Cl. G06T 17/20; G06T 15/20

(52) U.S. Cl. CPC G06T 17/20; G06T 15/20

(57) ABSTRACT

Aspects of the subject technology provide efficient rendering of three-dimensional scenes, including static or mostly static three-dimensional scenes. The efficient rendering may be achieved by providing a mesh atlas that helps to reduce the number of transparent pixels in a scene that are rendered, facilitate use of GPU depth testing to avoid rendering occluded pixels that are later replaced by opaque foreground pixels, and/or facilitate compact packing of image objects into an atlas. The mesh atlas can be generated in advance, and used at rendering time, for efficient rendering of a three-dimensional scene from a current point of view of a user.

### CROSS REFERENCE TO RELATED APPLICATIONS

This application claims the benefit of priority to U.S. Provisional Patent Application No. 63/597,677, entitled, “Atlased Coverage Mesh For Three-Dimensional Rendering”, filed on Nov. 9, 2023, the disclosure of which is hereby incorporated herein in its entirety.

### TECHNICAL FIELD

The present description relates generally to electronic devices including, for example, atlased coverage meshes for three-dimensional rendering.

### BACKGROUND

Electronic devices often include displays on which scenes are displayed. Typically, the scenes include objects that are arranged in two-dimensions on a two-dimensional display of an electronic device. Some electronic devices have two-dimensional displays with the capability of displaying scenes that appear to be arranged in three dimensions.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example system architecture including various electronic devices that may implement the subject system in accordance with one or more implementations.

FIG. 2 illustrates an example of an extended reality environment including multiple objects displayed, by an electronic device, to appear at multiple respective locations in a physical environment in accordance with aspects of the subject technology.

FIG. 3 illustrates a perspective view of the extended reality environment of FIG. 2 in accordance with one or more implementations.

FIG. 4 illustrates an example of an extended reality environment having user interface elements displayed in multiple discrete layers in accordance with one or more implementations.

FIG. 5 illustrates an example of a multi-sphere image representation of a three-dimensional scene in accordance with one or more implementations.

FIG. 6 illustrates an example of a multi-plane image representation of a three-dimensional scene in accordance with one or more implementations.

FIG. 7 illustrates an example of a rendered three-dimensional scene generated from a viewpoint using a multi-plane image representation of a three-dimensional scene in accordance with one or more implementations.

FIG. 8 illustrates an example of a two-dimensional image containing representations of objects in accordance with one or more implementations.

FIG. 9 illustrates an example of coverage meshes that can be generated for each of the objects in the two-dimensional image of FIG. 8 in accordance with one or more implementations.

FIG. 10 illustrates a mesh atlas in accordance with one or more implementations.

FIG. 11 illustrates a compact packing of a mesh atlas in accordance with one or more implementations.

FIG. 12 illustrates a compact packing of an image atlas using a mesh atlas in accordance with one or more implementations.

FIG. 13 illustrates an example of coverage meshes that can be generated for each of the objects in the two-dimensional image of FIG. 8, including a moving object, in accordance with one or more implementations.

FIG. 14 illustrates a mesh atlas for a three-dimensional scene including a moving object in accordance with one or more implementations.

FIG. 15 illustrates a flow diagram of an example process for generating a mesh atlas according to aspects of the subject technology.

FIG. 16 illustrates a flow diagram of an example process for rendering using a mesh atlas according to aspects of the subject technology.

FIG. 17 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Electronic devices often display information that is distributed, in two dimensions, on a two-dimensional display, such as a liquid crystal display or light-emitting diode (e.g., an organic light-emitting diode, or OLED), on which each display pixel is arranged to be viewed concurrently by both eyes of a user. Some electronic devices, such as XR headsets, have the capability of displaying information on one or more two-dimensional displays that appears, to a viewer of the display, to be distributed in three-dimensions (e.g., by displaying arranging the display(s) and/or portions thereof to be viewed differently by the two eyes of a user).

Implementations of the subject technology described herein can provide for efficient rendering of three-dimensional scenes, such as XR scenes. The efficient rendering may be used to render a view of a three-dimensional scene that is initially represented (e.g., stored) using one or more discrete layers of scene content that are spatially distributed across the three-dimensional scene. In some examples, the representation of the three-dimensional scene may be in the form of a multi-plane image (MPI) and/or multi-sphere image (MSI) representation.

The subject disclosure may provide various improvements and/or advantages over existing procedures for rendering scenes from multi-plane image (MPI) and/or multi-sphere image (MSI). In particular, rather than, or in addition to, storing rectilinear cutouts of image objects from an MPI or MSI in an atlas image, coverage meshes for image objects can be generated and stored in a mesh atlas.

In various implementations, the mesh atlas can be generated from an image atlas containing images of objects, or meshes can be generated directly from an MPI, MSI, or other layer-based three-dimensional representation, and subsequently packed together in a mesh atlas. As discussed in further detail hereinafter, the mesh atlas can provide efficiencies, relative to rendering using only an image atlas, by reducing the number of transparent pixels in a scene that are unnecessarily rendered, facilitating use of GPU depth testing to avoid rendering of occluded pixels that are later replaced by opaque foreground pixels, and/or facilitating compact packing of image objects into an atlas. In one or more implementations, a mesh atlas can be generated in advance and used, at rendering time, for efficient rendering of a three-dimensional scene from a current point of view of a user.

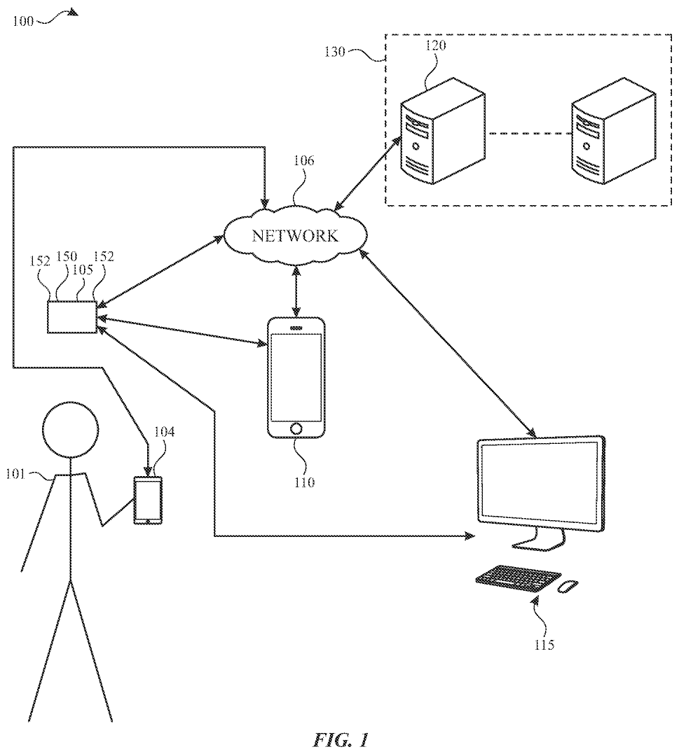

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, an electronic device 110, an electronic device 115, and a server 120. For explanatory purposes, the system architecture 100 is illustrated in FIG. 1 as including the electronic device 105, the electronic device 110, the electronic device 115, and the server 120; however, the system architecture 100 may include any number of electronic devices and any number of servers or a data center including multiple servers.

The electronic device 105 may be smartphone, a tablet device, or a wearable device such as a head mountable portable system, that includes a display system capable of presenting a visualization of an extended reality environment to a user 101. The electronic device 105 may be powered with a battery and/or any other power supply. In an example, the display system of the electronic device 105 provides a stereoscopic presentation of the extended reality environment, enabling a three-dimensional visual display of a rendering of a particular scene, to the user. In one or more implementations, instead of, or in addition to, utilizing the electronic device 105 to access an extended reality environment, the user may use an electronic device 104, such as a tablet, watch, mobile device, and the like.

The electronic device 105 may include one or more cameras such as camera(s) 150 (e.g., visible light cameras, infrared cameras, etc.) Further, the electronic device 105 may include various sensors 152 including, but not limited to, cameras, image sensors, touch sensors, microphones, inertial measurement units (IMU), heart rate sensors, temperature sensors, Lidar sensors, radar sensors, sonar sensors, GPS sensors, Wi-Fi sensors, near-field communications sensors, etc.) Moreover, the electronic device 105 may include hardware elements that can receive user input such as hardware buttons or switches. User input detected by such sensors and/or hardware elements correspond to various input modalities for interacting with virtual content displayed within a given extended reality environment. For example, such input modalities may include, but not limited to, facial tracking, eye tracking (e.g., gaze direction), hand tracking, gesture tracking, head tracking, pose tracking, biometric readings (e.g., heart rate, pulse, pupil dilation, breath, temperature, electroencephalogram, olfactory), recognizing speech or audio (e.g., particular hotwords), and activating buttons or switches, etc. The electronic device 105 may also detect and/or classify physical objects in the physical environment of the electronic device 105.

The electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power limitations of the electronic device 105 such as available battery power of the device. In response to power limitations, the electronic device 105 may deactivate certain sensors within the device itself to preserve battery power.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging and/or providing power to the electronic device 105 while physically connected).

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an implementation, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the extended reality environment in a real-time manner. In an example, the electronic device 105 provides a rendering of a scene corresponding to the extended reality environment that can be perceived by the user and interacted with in a real-time manner. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload.

The electronic device 105 may also detect events that have occurred within the scene of the extended reality environment. Examples of such events include detecting a presence of a living being such as a person or a pet, a particular person, entity, or object in the scene. Detected physical objects may be classified by electronic device 105, electronic device 110, and/or electronic device 115 and the location, position, size, dimensions, shape, and/or other characteristics of the physical objects can be used to provide physical anchor objects for an XR application generating virtual content, such as a UI of an application, for display within the XR environment.

It is further appreciated that the electronic device 110 and/or the electronic device 115 can also generate such extended reality environments either working in conjunction with the electronic device 105 or independently of the electronic device 105.

The network 106 may communicatively (directly or indirectly) couple, for example, the electronic device 105, the electronic device 110 and/or the electronic device 115 with the server 120 and/or one or more electronic devices of one or more other users. In one or more implementations, the network 106 may be an interconnected network of devices that may include, or may be communicatively coupled to, the Internet.

The electronic device 110 may include a touchscreen and may be, for example, a smartphone, a portable computing device such as a laptop computer, a peripheral device (e.g., a digital camera, headphones), a tablet device, a wearable device such as a watch, a band, and the like, any other appropriate device that includes, for example, processing circuitry, memory, a display, and/or communications circuitry for communicating with one or more other devices. In one or more implementations, the electronic device 110 may not include a touchscreen but may support touchscreen-like gestures, such as in an extended reality environment. In one or more implementations, the electronic device 110 may include a touchpad. In FIG. 1, by way of example, the electronic device 110 is depicted as a tablet device. In one or more implementations, the electronic device 110, the electronic device 104, and/or the electronic device 105 may be, and/or may include all or part of, the electronic system discussed below with respect to FIG. 17. In one or more implementations, the electronic device 110 may be another device such as an Internet Protocol (IP) camera, a tablet, or a peripheral device such as an electronic stylus, etc.

The electronic device 104 may include a touchscreen and may be, for example, a smartphone, a portable computing device such as a laptop computer, a peripheral device (e.g., a digital camera, headphones), a tablet device, a wearable device such as a watch, a band, and the like, any other appropriate device that includes, for example, processing circuitry, memory, a display, and/or communications circuitry for communicating with one or more other devices. In one or more implementations, the electronic device 104 may not include a touchscreen but may support touchscreen-like gestures, such as in an extended reality environment. In one or more implementations, the electronic device 104 may include a touchpad. In FIG. 1, by way of example, the electronic device 104 is depicted as a mobile smartphone device.

The electronic device 115 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 17.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an implementation, the server 120 may function as a cloud storage server that stores any of the aforementioned extended reality content generated by the above-discussed devices and/or the server 120.

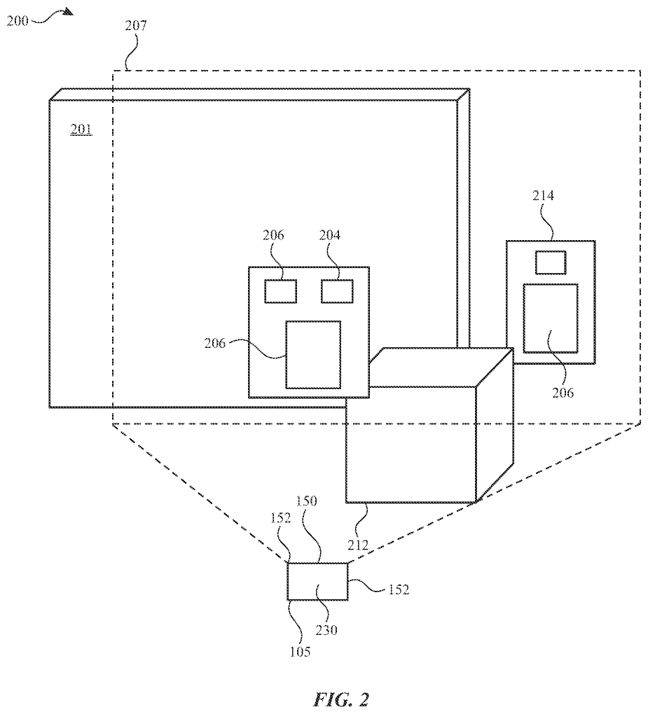

FIG. 2 illustrates an example of a physical environment 200 in which the electronic device 105 may be operated. In the example of FIG. 2, the physical environment 200 includes a physical wall 201 and a physical table 212. As shown, the electronic device 105 (e.g., display 230 of the electronic device 105) may display virtual content to be perceived by a user viewing the display 230 of the electronic device 105 at various locations in the physical environment 200 that are remote from the electronic device 105. When the virtual content is displayed by the electronic device 105 to cause the virtual content to appear to the user to be in the physical environment 200, the combined physical environment and the virtual content may form an XR environment. In one or more other implementations, the XR environment may be an entirely virtual environment the virtual content displayed in a manner that blocks the user's view of the physical environment 200.

In the example of FIG. 2, the display 230 of electronic device 105 displays an object 204 and an object 214. As examples, the objects 204 and 214 may include static objects such as application icons, widgets, user interfaces (UIs), scene objects such as virtual trees, virtual tables, virtual chairs, virtual mountains, virtual foliage, and/or any other virtual objects. In one illustrative example, the object 204 may be an icon of a first application (or operating system process) installed on the electronic device 105, and the object 214 may be an icon of a second application (or operating system process) installed on the electronic device 105. An icon of an application may include a logo and/or title of the application, and may be selectable to launch a user interface of the application.

As shown in FIG. 2, the object 204 and/or object 214 may include one or more sub-objects 206. Sub-objects 206 may include images, designs, text, text entry fields, buttons, selectable tools, scrollbars, menus, drop-down menus, links, plugins, image viewers, media players, sliders, scrubbers, gaming characters, other virtual content, or the like. Sub-objects 206 may include two-dimensional elements and/or three-dimensional elements. In the illustrative example of FIG. 2, the objects 204 and 214, and the sub-objects 206 are rectangular objects. However, this is merely illustrative, and the objects 204 and 214, and the sub-objects 206 may have any shape, including shapes less and more complex than a rectangular shape.

As shown in FIG. 2, the object 204 and the object 214 are displayed in a viewable area 207 of the display 230 of the electronic device 105. As shown, the object 204 and the object 214 may be displayed to be perceived by a user of the electronic device 105 (e.g., a view of the display 230) at different respective distances from the electronic device 105. In the example of FIG. 2, the object 204 appears to be at a distance that is closer to the electronic device 105 (e.g., and partially in front of a physical table 212 in the physical environment 200) than the apparent distance of the object 214 (e.g., which may appear partially behind the physical table 212). In one or more other implementations, the XR environment may be an entirely virtual environment in which the object 204 and the object 214 are displayed in a manner that blocks the user's view of the physical environment 200 (e.g., over a virtual background display by the display 230 of the electronic device 105).

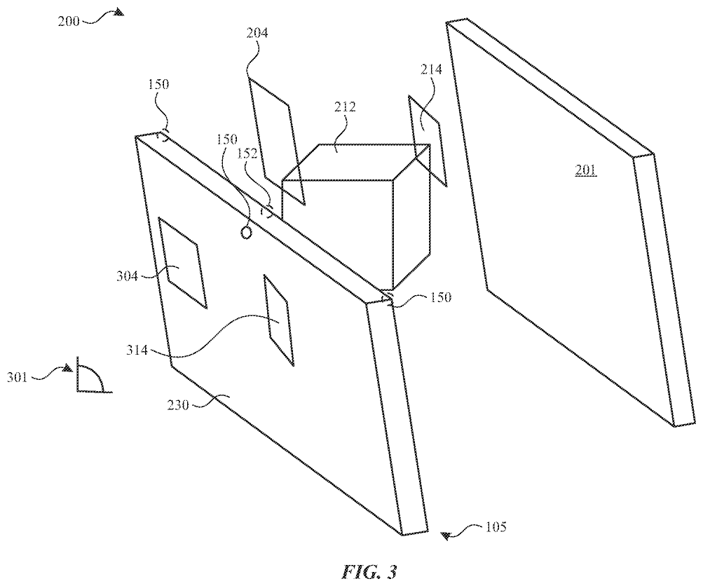

FIG. 3 illustrates a perspective view of the XR environment of FIG. 2. As illustrated in FIG. 3, a representation 304 of the object 204 may be displayed on the display 230 such that the object 204 appears to a viewer 301 of the display 230 as if disposed in front of the physical table 212 in the physical environment 200. In this example, a representation 314 of the object 214 appears to the viewer 301 as if disposed partially behind the physical table 212 in the physical environment 200. In one or more implementations, the object 204 and/or the object 214 can be displayed, moved, and/or interacted with using three-dimensional gestures and/or movements detected by the electronic device 105.

In one or more implementations, the information that is used by the electronic device 105 to generate the XR environment of FIGS. 2 and 3 may include the locations of the objects 204 and 214, and textures that describe the appearance of the objects 204 and 214. This information may be stored in any of various formats. For example, as described in further detail hereinafter, in one or more implementations, the information for rendering the three-dimensional scene to appear as shown in FIGS. 2 and 3 may be stored in a representation of the three-dimensional scene that includes multiple discrete layers of scene content (e.g., the objects 204 and 214, and/or the sub-objects 206) that are spatially distributed across the three-dimensional scene (e.g., in planar, spherical, or other discrete layers).

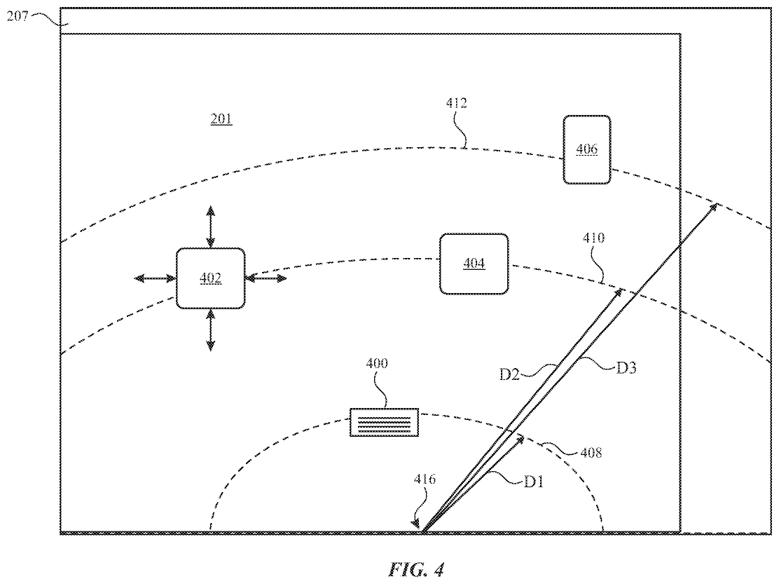

For example, FIG. 4 illustrates an XR environment in which objects in a three-dimensional scene are displayed to appear at various locations that correspond to multiple discrete layers of scene content. In the example of FIG. 4, the objects in each of the discrete layers are displayed to appear at a different predefined (e.g., predefined prior to presentation of the information) distances from the user and/or the electronic device 105. In the example of FIG. 4, an object 400 is displayed at a distance corresponding to a layer 408, an object 402 and an object 404 are displayed at a distance corresponding to a layer 410, and an object 406 is displayed at a distance corresponding to a layer 412. Rendering the view of the three-dimensional scene that is shown in FIG. 4 can include determining the distance at which to render the object 400 based on a depth of the layer 408, determining the distance at which to render the objects 402 and 404 based on a depth of the layer 410, and determining the distance at which to render the object 406 based on a depth of the layer 412.

In the example of FIG. 4, the layer 408 may be a sphere at a first distance d1 from the electronic device 105, the layer 410 may be a sphere at a second distance d2, larger than the distance d1, from the electronic device 105, and the layer 412 may be a sphere at a third distance d3, larger than the second distance d2, from the electronic device. For example, each of the layers 408, 410, and 412 may be a sphere with a center point 416. In the example of FIG. 4, the center point 416 of the layers 408, 410, and 412 is the same as the location of the electronic device 105 that is displaying the objects 400, 402, 404, and 406. However, as described in further detail hereinafter the locations of the objects 400, 402, 404, and 406 in the layers 408, 410, and 412 can also be used to render a view of the objects 400, 402, 404, and 406 from other viewpoints within the three-dimensional scene.

As illustrated in FIG. 4, one or multiple objects can be displayed at various angular locations that are all at the same distance corresponding to each layer. In the example of FIG. 4, one object (e.g., object 400) is displayed at a distance that is based on the layer 408, two objects (e.g., object 402 and object 404) are displayed different angular locations at the same distance that is based on the layer 410, and one object (e.g., object 406) is displayed at a distance that is based on the layer 412. However, this is merely illustrative, and any number of objects can be displayed within each discrete distance layer in various use cases. Although three layers, at three respective distances/radii, are shown in the example of FIG. 4, in other examples, more than three or fewer than three layers can be included in a representation of a three-dimensional scene that is used to render a view of that scene by an electronic device such as the electronic device 105.

For example, FIG. 5 illustrates an example of a multi-sphere representation of a three-dimensional scene in accordance with one or more implementations. For example, a multi-sphere image (MSI) representation can be generated and stored, and later used to render a view of the three-dimensional scene of the types shown in FIGS. 2-4. For example, the MSI representation 501 of FIG. 5 includes the layer 408, the layer 410, and the layer 412 of FIG. 4, and an additional layer 500. In this example, the layer 408, the layer 410, the layer 412, and the layer 500 are spherical layers at discrete distances (e.g., radii in this example) d1, d2, d3, and d4, respectively, from the center point of the spherical layers (which may be used as a reference viewpoint).

In the example of FIG. 5, the three-dimensional scene that is represented by the MSI representation 501 includes a first object 502 in the layer 408, a second object 504 in the layer 410, no objects in the layer 412, and an object 506 in the layer 500. This is merely illustrative, and any number of objects may be included in any of the layers 408, 410, 412, and/or 500. In this example, the objects 502, 504, and 506 have been given distinctive shapes (a circle, a star, and a square) for illustrative purposes. However, it is appreciated that the objects 502, 504, and 506 may have the same or different shapes, and may represent objects with more or less complex shapes than those shown in FIG. 5. As examples, the objects 502, 504, and/or 506 may represent user interface elements, application icons, scene objects (e.g., furniture, foliage, other background objects), virtual characters, static objects, interactive objects, and/or any other virtual objects that can be displayed in an XR scene.

In order to render a view of a three-dimensional scene from using the MSI representation 501, a viewpoint 510 may be selected. The viewpoint 510 may be a reference viewpoint, and may include a viewing location 511, and a viewing angle. In the example of FIG. 5, the viewing location 511 is at the center of the spherical layers (e.g., as in the example of FIG. 4), and the viewing angle is along the “y” direction shown in the figure. For example, the viewpoint 510 may be determined based on the location, pose, and/or gaze of the user 101 and/or the electronic device 105. Based on this viewpoint 510, a view 512 of the three-dimensional scene that is represented by the MSI representation 501 can be rendered.

As shown, in the rendered view 512 from the viewpoint 510, the object 502 appears partially in front of the object 506 and appears larger, relative to the size of the object 506, than in the MSI representation 501 due to the shorter distance d1, versus the distance d4 of the location of the object 506. In this example, the object 504 appears to the right of, and separated from, the objects 502 and 506. The rendered view 512 may be displayed by a display of an electronic device, such as the electronic device 105.

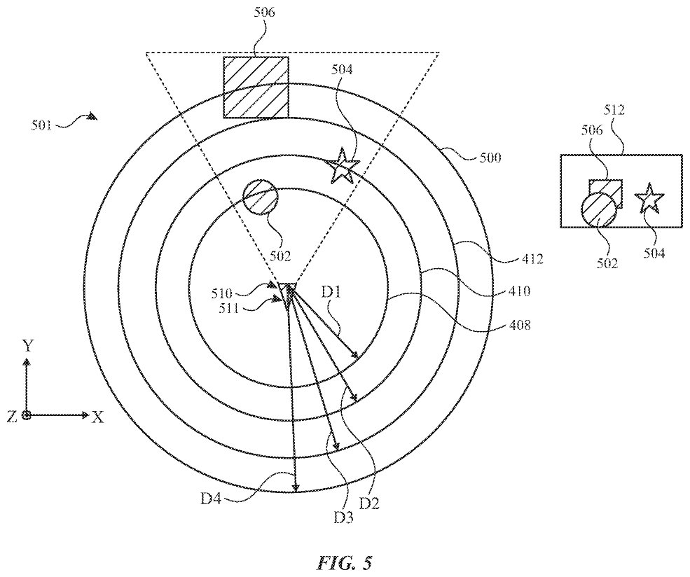

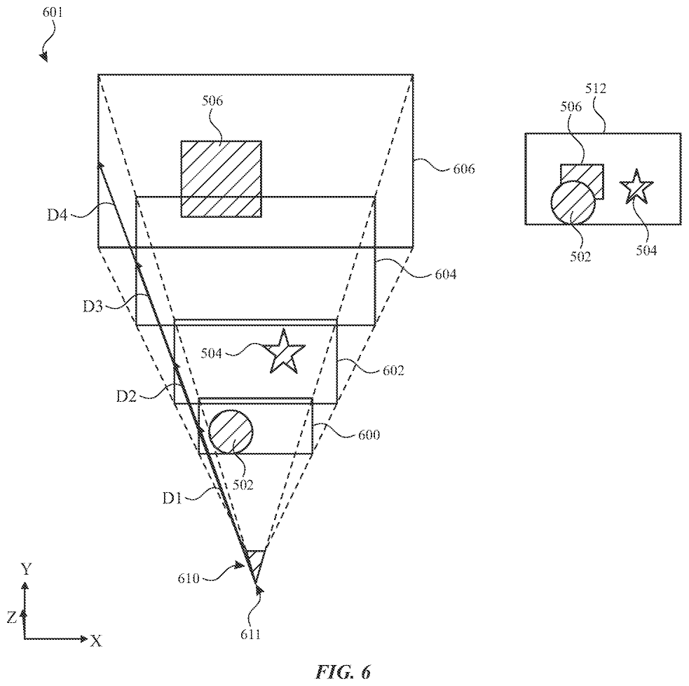

Although spherical layers at constant distances are depicted in FIGS. 4 and 5, other layer-based representations of three-dimensional scenes (e.g., a planar representation in which the discrete layers are planar layers, or other representations with non-planar and non-spherical layers that are separated from each other within the three-dimensional scene) can produce the same or similar rendered views. For example, FIG. 6 illustrates how the same three-dimensional scene that is represented by the spherical layers of the MSI representation 501 of FIG. 5 can be represented by planar layers in a multi-plane image (MPI) representation 601.

For example, the MPI representation 601 of FIG. 6 includes a layer 600 at a distance (depth) D1, a layer 602 at a distance (depth) D2, a layer 604 at a distance (depth) D3, and a layer 606 at a distance (depth) D4. This is merely illustrative, and more or fewer than four layers at any respective distances can be included in the MPI representation 601. In this example, the layer 600, the layer 602, the layer 604, and the layer 606 are planer layers at discrete distances D1, D2, D3, and D4, respectively, from a reference point 611 associated with a reference viewpoint 610. As shown, when rendered from the viewpoint 610, the MPI representation 601 of the three-dimensional scene generates the same rendered view 512 as the MSI representation 501 generates when rendered from the viewpoint 510.

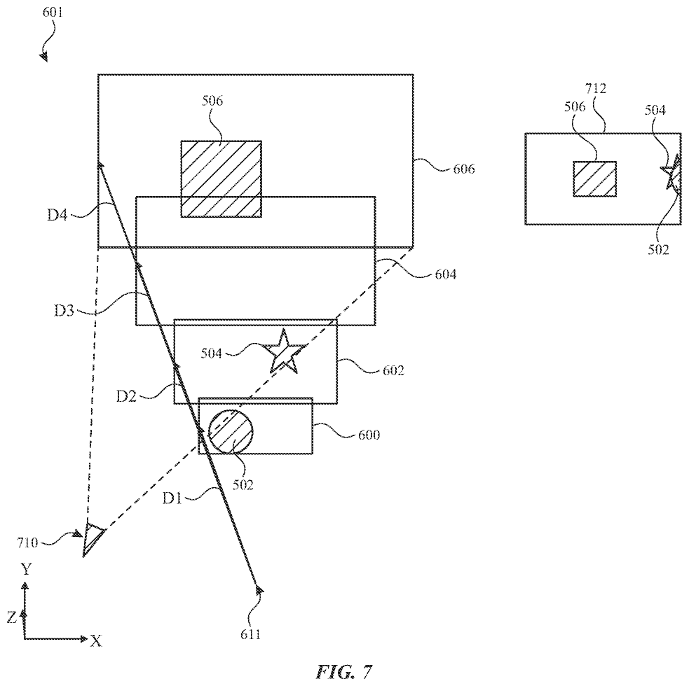

The viewpoints 510 and 610 of FIGS. 5 and 6 are merely illustrative, and the MSI representation 501 and/or the MPI representation 601 can be used to render views of the three-dimensional scene from any of various viewpoints (e.g., depending on the location, position, motion, and/or rotation of a user's head while wearing the electronic device 105). For example, FIG. 7 illustrates a view 712 of the three-dimensional scene that is represented by the MPI representation 601, from a viewpoint 710 that is separate from the reference point 611 for the layers 600, 602, 604, and 606. As shown, in the rendered view 712 from the viewpoint 710, the object 502 appears partially in front of the object 504 and appears larger, relative to the size of the object 504, than in the MPI representation 601 due to the shorter distance D1, versus the distance D2 of the object 504. In the view 712, the object 502 and the object 504 are both cut off by a boundary of the view (e.g., which may correspond to a boundary of a display of the electronic device 105 and/or the boundary of the estimated peripheral vision of the user 101). In this example, the object 506 appears to the left of, and separated from, the objects 502 and 504. The rendered view 712 may be displayed by a display of an electronic device, such as the electronic device 105.

The MSI representation 501 and the MPI representation 601 are merely illustrative of representations of three-dimensional scenes that include multiple discrete layers of scene content that are spatially distributed across the three-dimensional scene. In various other examples, the discrete layers of a representation of a three-dimensional scene can have shapes other than spherical or planar shapes. Whether in an MSI representation, an MPI representation, or another representation of the three-dimensional scene that includes multiple discrete layers of scene content that are spatially distributed across the scene, each layer may have an associated Red, Green, Blue, α (RGBα) texture, and can be placed at a predetermined (e.g., fixed) depth, distance, and/or radius from a reference viewpoint in the scene. The RGB channels of the texture of each layer may capture the color content of the scene, and the alpha channel of each layer may identify the (e.g., approximate) depths at which content from that layer is located in the scene. For example, objects that are close to the reference viewpoint in the scene may be captured by opaque RGBα content in the textures for layer(s) with smaller depths/distances/radii, and objects at relatively further distances may be represented by opaque RGBα content in the deeper/further/larger layers. By using a finite number of discrete layers, these representations of the three-dimensional scene may discretize the depth information for the scene.

In one or more implementations, relevant information for rendering a view from the MSI representation 501 or the MPI representation 601 can be stored in the form of a two-dimensional image containing representations of the objects therein. For example, FIG. 8 illustrates a two-dimensional image 800 containing representations of the object 502, the object 504, and the object 506. For example, the two-dimensional image 800 may include a cutout image 802 (e.g., a cutout RGBα image) containing the object 502 from the layer 408 of the MSI representation 501 or from layer 600 of the MPI representation 601. The two-dimensional image 800 may include a cutout image 804 (e.g., a cutout RGBα image) containing the object 504 from the layer 410 of the MSI representation 501 or from layer 602 of the MPI representation 601. The two-dimensional image 800 may include a cutout image 806 (e.g., a cutout RGBα image) containing the object 506 from the layer 500 of the MSI representation 501 or from layer 606 of the MPI representation 601. The two-dimensional image 800 may include or be stored with metadata that maps each of the cutout images 802, 804, and 806 to the corresponding layer of the of the MSI representation 501 or the MPI representation 601. The two-dimensional image 800 and its metadata may be referred to herein as an atlas image in some examples.

In order to render a view of the three-dimensional scene, each layer of the MSI representation 501 or the MPI representation 601 may be projected to a viewpoint (e.g., viewpoint 510 or 710), and an alpha-composite may be performed from back-to-front of each layer's RGBα texture. For example, performing the alpha-composite may include rendering each of the cutout images 802, 804, and 806 at the distance corresponding to its respective layer in the MSI representation 501 or the MPI representation 601, and according to the RGB values of the cutout images. However, rendering based on the MSI representation 501 or the MPI representation 601, or based on the two-dimensional image 800 generated therefrom, may result in a large number of transparent pixels being rendered without any visible benefit in the rendering. For example, rendering the cutout image 802 would include rendering the pixels corresponding to the object 502 and (e.g., unnecessarily) rendering the transparent pixels 808 surrounding the object 502 within the cutout image 802. Similarly, rendering the cutout image 804 would include rendering the pixels corresponding to the object 504 and (e.g., unnecessarily) rendering the transparent pixels 810 surrounding the object 504 within the cutout image 804. More complex object shapes can result in even more transparent pixels rendered than those shown for objects 502 and 504. Moreover, rendering from back to front, based on the MSI representation 501 or the MPI representation 601, or based on the two-dimensional image 800 generated therefrom, can cause occluded background content (e.g., an occluded portion of object 506 in the examples of FIGS. 5 and 6, or an occluded portion of object 504 in the example of FIG. 7) to be rendered first, then later overwritten by foreground content (e.g., a foreground portion of object 502 in the examples of FIGS. 5, 6, and 7), making the rendering operations for the occluded portions an unnecessary use of computing and power resources.

Aspects of the subject technology can address these and/or other performance limitations of rendering MPIs/MSIs, such as by providing atlased alpha coverage meshes. For example, as illustrated by FIG. 9, in one or more implementations a respective coverage mesh may be generated for each of the objects in the three dimensional scene. In the example of FIG. 9, a coverage mesh 902 is generated for the object 502, a coverage mesh 904 is generated for the object 504, and a coverage mesh 906 is generated for the object 506. The coverage meshes 902, 904, and 906 may be generated from the cutout images 802, 804, and 806, or may be generated directly from the representation of the three-dimensional scene (e.g., the MSI representation 501 or the MPI representation 601). In this and other examples described herein, a coverage mesh is generated for each object. However, it is appreciated that the coverage meshes may not necessarily each correspond to a single object. For example, the coverage meshes may correspond to depth layers from the original representation of the scene, each of which may include multiple components of a scene, and/or a subset of individual components. In some use cases, a coverage mesh may include portions of multiple objects. In some use cases, a coverage mesh may include only a portion of an object.

For example, the coverage meshes 902, 904, and 906 may be generated by identifying the non-transparent pixels in each layer and/or for each object (e.g., using the a values in the cutout images 802, 804, and 806, or in the MSI representation 501 or the MPI representation 601), and identifying a set of vertices 910 for the coverage mesh for each layer and/or each object. Each vertex 910 may include three coordinates in the three-dimensional space in which an object or other scene component is to be rendered to appear, and two coordinates that map to the pixels of the object or other scene component in the two-dimensional image 800. For example, in one or more implementations, in order to generate the vertices 910, a quad can be created per opaque pixel of each object. One or more mesh simplification operations can then be applied to reduce the polygon count and create a coarser coverage mesh for each object. For example, there exists a tradeoff between the coarseness of the coverage meshes and the tightness to which the coverage meshes fit the opaque scene content. There is also a tradeoff between the benefit of reducing the rendering operations for transparent pixels, and increasing the number of vertices to be processed when rendering using the coverage meshes (e.g., using a coarse mesh will reduce the vertex count of the mesh, but will increase the number of transparent pixels needlessly rendered, and vice versa). In one or more implementations, the coarseness of the coverage meshes may be tuned, using a rendering-optimization process, to balance work for processing the number of vertices to the work for rendering the resulting number of excess transparent pixels.

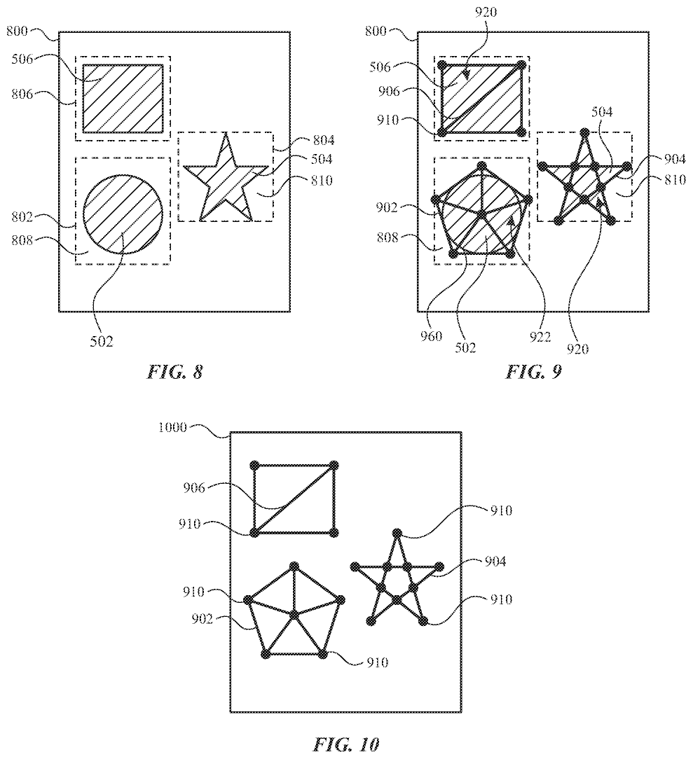

As shown in FIG. 10, the coverage meshes 902, 904, and 906, for the respective objects 502, 504, and 506, may be stored in a mesh atlas 1000. In the example of FIG. 10, for illustrative purposes, the mesh atlas 1000 is depicted in the form of a two-dimensional image including the coverage meshes 902, 904, and 906. However, it is appreciated that the mesh atlas 1000 including coverage meshes may be stored in any suitable form, including, as examples, a list or table of sets of vertices that are indexed to a particular object. For example, the mesh atlas 1000 may be stored as metadata of the two-dimensional image 800 in some examples. In one or more implementations, generating the mesh atlas 1000 may include generating the coverage meshes 902, 904, and 906 from the two-dimensional image 800. In one or more other implementations, generating the mesh atlas 1000 may include generating the coverage meshes 902, 904, and 906 directly from the MSI representation 501 or the MPI representation 601 (e.g., without first generating the two-dimensional image 800). In these other implementations, the two-dimensional image 800 may be generated using the mesh atlas 1000 and the MSI representation 501 or the MPI representation 601.

Once the mesh atlas 1000 is generated, rendering a view, such as the view 512, the view 712, or any of the views of FIGS. 2-4, may include rendering the coverage meshes, and thereby discarding most or all of the transparent parts of the scene before rendering, since the transparent portions (e.g., transparent pixels 808 and 810 of the cutout images 802 and 804) are not covered by the coverage meshes and are therefore not rendered. This reducing of the number of transparent pixels that are rendered can help to provide efficient rendering of three-dimensional scenes. Rendering a coverage mesh corresponding to a scene object or a scene layer may include determining where, in three-dimensional space, the vertices of each coverage mesh are located (e.g., without referring to the layers of the MSI representation 501 or the MPI representation 601), obtaining a set of pixels (e.g., for the texture of the object) from the portion(s) of the two-dimensional image 800 corresponding to the vertices for that coverage mesh, and rendering the obtained set of pixels to appear at the determined location in three-dimensional space.

Using (e.g., by performing depth testing of the vertices, such as by a graphics processing unit (GPU), during rendering) the vertices of the coverage meshes in the mesh atlas 1000, which indicate the three-dimensional locations of the objects 502, 504, and 506 (e.g., without referring back to the layer of the original representation of the three-dimensional scene), the rendering may include rendering the objects 502, 504, and 506 from front (e.g., locations that are apparently closest to the user 101) to back (e.g., locations that are apparently further from the viewpoint of the user 101). For example, the object 502 may be rendered first, and only portions of the objects 504 and 506 that are not occluded by the object 502 may then be rendered. In this way, the rendering process can identify occluded portions of the objects 502, 504, and/or 506 before rendering those occluded portions, so that the occluded portions are not rendered (e.g., as they would be later overwritten by foreground portions of others of the objects 502, 504, and/or 506), and further efficiency in the rendering of the view of the three-dimensional scene can be achieved.

Referring back to FIG. 9, in one or more implementations, some portions of a coverage mesh (e.g., portions 920) may cover only opaque pixels of an object, and other portions of a coverage mesh (e.g., portion 922) may cover some opaque pixels of an object and some transparent pixels around the object (e.g., due to the shape of the object and/or a limitation on the number of vertices used for the coverage mesh). In one or more implementations, the mesh atlas 1000 may be segmented or split so that one mesh atlas includes portions 920 of the coverage meshes covering solely opaque pixels, and another mesh atlas includes the portions 922 of the coverage meshes containing a mix of transparent and opaque pixels. In this way, portions of the scene that are identified in the first mesh atlas (that includes portions 920 of the coverage meshes covering solely opaque pixels) may be rendered by reading and writing depth information (e.g., to a depth buffer or z-buffer) during depth testing for front-to-back efficient rendering (e.g., rendering operations that provide efficiencies by avoiding rendering pixels of background objects that are later superseded by pixels of nearer objects that occlude those back ground objects), and portions of the scene that are identified in the second mesh atlas (that includes portions 922 of the coverage meshes containing a mix of transparent and opaque pixels) may be rendered only by reading depth information (e.g., from the depth buffer or z-buffer) without writing depth information (e.g., to the depth buffer or z-buffer) during depth testing for the rendering operation. However, it is appreciated that, even without being able to write depth information during depth testing, the portions 922 of the coverage meshes still may drastically reduce the number of transparent pixels that are rendered, relative to rending based on the two-dimensional image 800 without the mesh atlas.

In the example of FIG. 9, the coverage mesh 904 and the coverage mesh 906 are each a single respective coverage mesh corresponding to all pixels of the objects 504 and 506, respectively. In this example, the coverage mesh 902 for the object 502 includes only portions 922 that correspond to a set of opaque pixels of the object 502 and to a set of transparent pixels outside a boundary 960 of the object 502. In one or more implementations, the coverage mesh for an object having a more complex shape than the simple shapes shown in FIGS. 8 and 9 may include some portions (e.g., one or more first respective coverage meshes, such as one or more portions 920) that correspond to only opaque pixels of the that object, and other portions (e.g., one or more second respective coverage meshes, such as one or more portions 922) that correspond to a set of opaque pixels of the object and to a set of transparent pixels outside a boundary of the object.

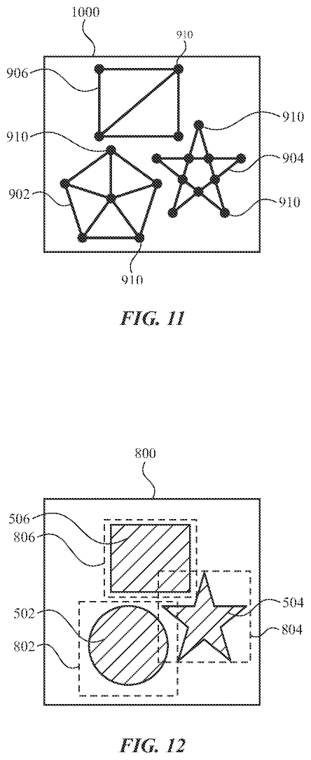

In one or more implementations, generating the mesh atlas directly from the representation of the three-dimensional scene that includes discrete layers of scene content that are spatially distributed across the three-dimensional scene (e.g., directly from the MSI representation 501 or the MPI representation 601), before generating the two-dimensional image 800, can facilitate additional efficiencies, such as by facilitating compact packing of the mesh atlas and the image atlas. For example, FIG. 11 illustrates a mesh atlas 1000 that has been generated prior to generating a two-dimensional image with cutouts corresponding to the objects 502, 504, and 506. As shown, because the coverage meshes 902, 904, and 906 do not cover many of the transparent portions of the cutout images 802, 804, and 806 shown in FIG. 8, the coverage meshes can be more tightly and/or compactly packed into the mesh atlas 1000 (e.g., in comparison with the mesh atlas 1000 in FIG. 10, in which the layout of the coverage meshes is set by the layout of the cutout images 802, 804, and 806 shown in FIG. 8).

As shown in FIG. 12, the two-dimensional image 800 (e.g., the image atlas) can then be generated using the mesh atlas 1000 of FIG. 11 to set the layout of the cutout images 802, 804, and 806 in the two-dimensional image 800. As shown in FIG. 12, in this way, the transparent portions of the cutout images 802, 804, and 806 can overlap with transparent and/or opaque portions of other cutout images 802, 804, and 806, to compactly pack the cutout images 802, 804, and 806 into the two-dimensional image 800. In the example of FIGS. 11 and 12, the vertices 910 of the coverage meshes 902, 904, and 906 are generated to include two-dimensional coordinates that map to the two-dimensional image 800, before the two-dimensional image 800 is generated. The cutout images 802, 804, and 806 can then be placed into the two-dimensional image at locations that are determined using the two-dimensional coordinates of the vertices 910 of the respective coverage meshes 902, 904, and 906.

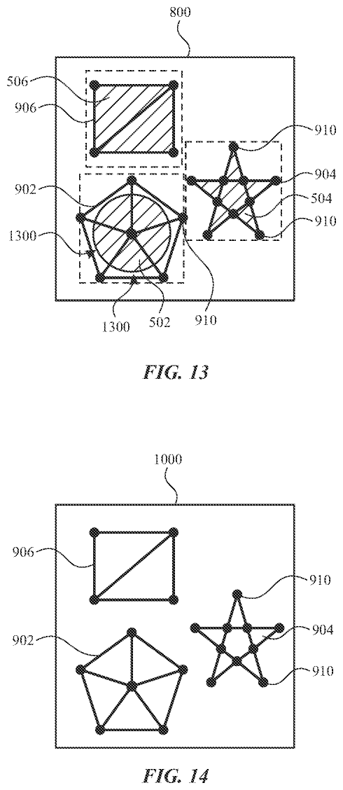

In one or more implementations, representing a three-dimensional scene using multiple discrete layers (e.g., an MSI representation, an MPI representation, or other layer-based representation), and/or compacting the information from that representation into a mesh atlas 1000 and a two-dimensional image 800, can be particularly useful for three-dimensional scenes that are static or nearly static. However, in one or more implementations, a mesh atlas 1000 and a two-dimensional image 800 may be generated for rendering of a three-dimensional scene that includes some animated and/or moving content. For example, in one or more implementations, one or more of the objects 502, 504, and 506 may be configured to bounce, wiggle, vibrate, grow, shrink, or otherwise move or change, when a user interacts with that object. In order to accommodate small movements and/or changes of an object (e.g., movements and/or changes over distances that are smaller than a largest dimension of the object), the coverage mesh for the moving object may be expanded. For example, FIG. 13 illustrates an example use case in which the object 502 may be configured to bounce, wiggle, vibrate, or make other small movements when a user interacts with the object 502.

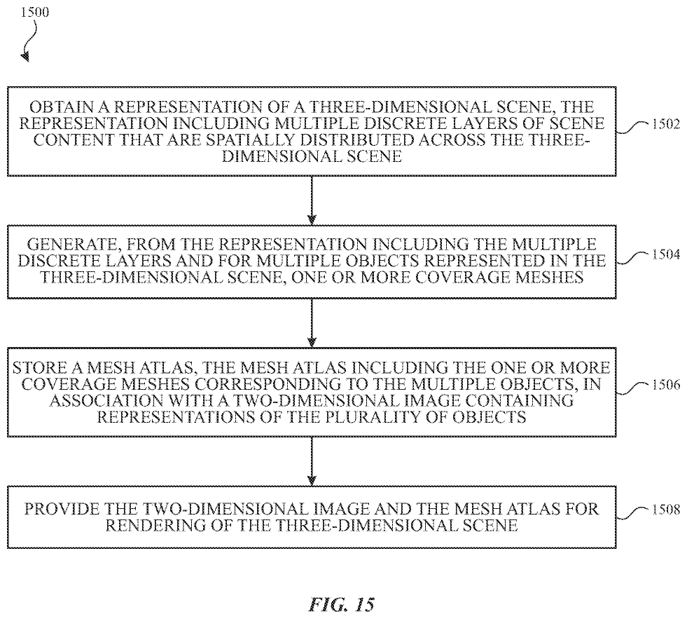

As shown in FIG. 13, the coverage meshes 904 and 906 may be tightly fit to the shapes of the objects 504 and 506 (e.g., stationary objects) as in the example of FIG. 9, and the coverage mesh 902 may be expanded relative to the shape of the object 502 (e.g., and relative to the size of the coverage mesh 902 shown in FIGS. 9-11). For example, coverage mesh 902 may be generated such that the coverage mesh 902 covers the shape of the object 502 and a gap 1300 that covers the area over which the object 502 may move in the three-dimensional scene. FIG. 14 illustrates the mesh atlas 1000 with the expanded coverage mesh 902.

In one or more implementations, for objects with continuous movements across the scene, larger movements than the size of the object, and/or other animations, the mesh atlas 1000 and the two-dimensional image 800 may be generated or updated for each of several time periods during the movement or animation. In this way, the movement and/or animation of the object within each time period may be small, and the expanded coverage mesh may cover the area within which the object moves within that time period.

FIG. 15 illustrates a flow diagram of an example process 1500 for generating a mesh atlas in accordance with implementations of the subject technology. For explanatory purposes, the process 1500 is primarily described herein with reference to the electronic device 105 of FIG. 1. However, the process 1500 is not limited to the electronic device 105 of FIG. 1, and one or more blocks (or operations) of the process 1500 may be performed by one or more other components of other suitable devices, including the electronic device 104, the electronic device 110, and/or the electronic device 115. Further for explanatory purposes, some of the blocks of the process 1500 are described herein as occurring in serial, or linearly. However, multiple blocks of the process 1500 may occur in parallel. In addition, the blocks of the process 1500 need not be performed in the order shown and/or one or more blocks of the process 1500 need not be performed and/or can be replaced by other operations.

As illustrated in FIG. 15, at block 1502, a representation (e.g., MSI representation 501, MPI representation 601, or another representation) of a three-dimensional scene (e.g., the three-dimensional scene of any of FIG. 3, 4, 5, 6, or 7) may be obtained (e.g., by an electronic device, such as electronic device 105). Obtaining the representation of the three-dimensional scene may include generating the representation, or obtaining a stored, previously generated, representation, such as from local memory or from a remote source or serve). The representation may include multiple discrete layers (e.g., spherical layers such as layers 408, 410, 412, and 500, planar layers such as layers 600, 602, 604, and 606, or layers having other shapes and/or sizes) of scene content (e.g., objects 204, 214, 400, 402, 404, 406, 502, 504, and/or 506). The multiple discrete layers may be spatially distributed across the three-dimensional scene (e.g., as illustrated in any of FIGS. 4-7).

In one or more implementations, each of the multiple discrete layers of scene content may represent a respective depth in the three-dimensional scene. In one example, each of the multiple discrete layers may include a spherical layer. In another example, each of the discrete layers may include a planar layer.

At block 1504, for multiple objects (e.g., objects 204, 214, 400, 402, 404, 406, 502, 504, and/or 506) represented in the three-dimensional scene, one or more coverage meshes corresponding to the multiple objects (e.g., coverage meshes 902, 904, and/or 906 for objects 502, 504, and/or 506) may be generated (e.g., by an electronic device, such as electronic device 105) from the representation that includes the multiple discrete layers. For example, at least one of the one or more coverage meshes corresponding to the multiple objects may include vertex information for a boundary (e.g., boundary 960) of one of the multiple objects. For example, the vertex information for a coverage mesh may include three-dimensional coordinates for the locations each of multiple vertices (e.g., vertices 910) in the three-dimensional scene, and two-dimensional coordinates of each of the multiple vertices in the two-dimensional image (e.g., coordinates mapping to the representation of the corresponding object, for that coverage mesh, in the two-dimensional image).

In one or more implementations, the process 1500 may also include determining a number of vertices for the one of the multiple objects by performing an optimization process based on candidate numbers of the vertices and a number of transparent pixels associated with the one of the plurality of objects. For example, the optimization process may include selecting, from the candidate numbers of vertices, a number of vertices that optimally reduces the number of transparent pixels to be rendered, in balance with a cost of processing each vertex. In one or more implementations, generating the at least one of the one or more coverage meshes for the one of the multiple objects may include generating the vertex information for the boundary of the one of the multiple objects by obtaining the vertex information for each of the determined number of vertices for the one of the multiple objects.

In one or more implementations, generating the one or more coverage meshes corresponding to the multiple of objects may include generating, for a first one of the multiple objects (e.g., object 504 or object 506), a single respective coverage mesh (e.g., including only portion(s) 920) corresponding to all pixels of the first one of the plurality of objects, and generating, for a second one of the multiple objects (e.g., object 502), first and second respective coverage meshes. The first respective coverage mesh (e.g., a portion 920) may correspond to only opaque pixels of the second one of the plurality of objects, and the second respective coverage mesh (e.g., a portion 922) may correspond to a set of opaque pixels of the second one of the plurality of objects and to a set of transparent pixels outside a boundary (e.g., boundary 960) of the second one of the plurality of objects.

At block 1506, a mesh atlas (e.g., mesh atlas 1000) may be stored (e.g., by an electronic device, such as electronic device 105). The mesh atlas may include the one or more coverage meshes corresponding to the multiple objects. The mesh atlas may be stored in association with a two-dimensional image (e.g., two-dimensional image 800) containing representations (e.g., cutout images 802, 804, and/or 806) of the multiple objects. In one or more implementations, storing the mesh atlas may include storing the mesh atlas as metadata for the two-dimensional image containing the representations of the plurality of objects. In one or more implementations, the mesh atlas may be stored as a list or table of vertex information, the vertex information including, for each object, a set of coordinates for each of a set of vertices.

In one or more implementations, generating the one or more coverage meshes corresponding to the multiple objects at block 1504 may include generating the two-dimensional image containing the representations of the multiple objects, and generating the one or more coverage meshes corresponding to the multiple objects based on the two-dimensional image (e.g., based on the alpha values in the two-dimensional image). In one or more other implementations, generating the one or more coverage meshes corresponding to the multiple objects may include generating the one or more coverage meshes corresponding to the multiple objects based on the representation of the three-dimensional scene, and the process 1500 may also include generating the two-dimensional image based on the one or more coverage meshes corresponding to the multiple objects and based on the representation of the three-dimensional scene (e.g., by extracting cutout images from the multiple discrete layers according to vertex information in the respective coverage meshes).

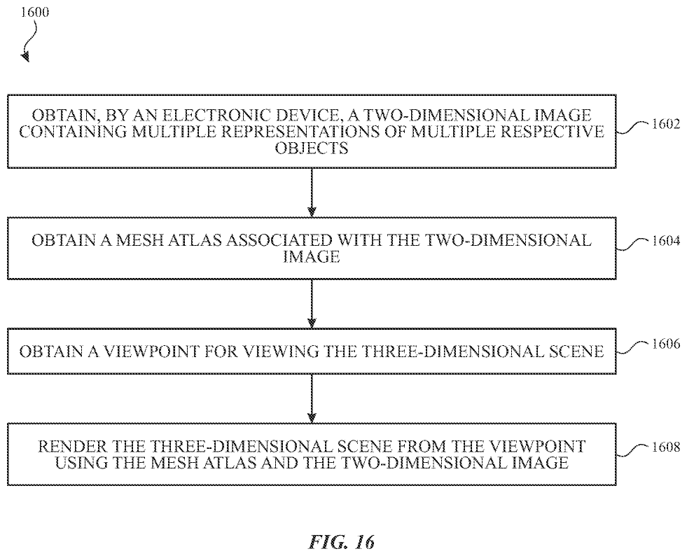

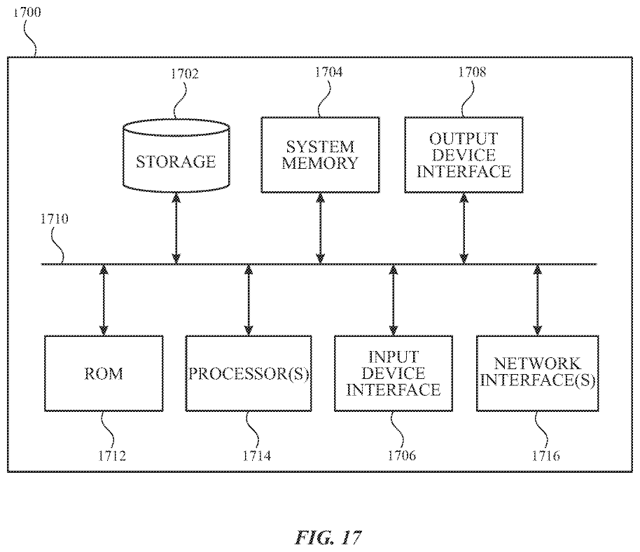

At block 1508, the two-dimensional image and the mesh atlas may be provided (e.g., to a renderer at an electronic device, such as electronic device 105) for rendering of the three-dimensional scene (e.g., by an electronic device, such as electronic device 105). The process 1500 may also include rendering a view of the three-dimensional scene using the mesh atlas and the two-dimensional image. Rendering the view of the three-dimensional scene may include performing some or all of the process 1600 of FIG. 16.

For example, FIG. 16 illustrates a flow diagram of an example process 1600 for rendering a three-dimensional scene in accordance with implementations of the subject technology. For explanatory purposes, the process 1600 is primarily described herein with reference to the electronic device 105 of FIG. 1. However, the process 1600 is not limited to the electronic device 105 of FIG. 1, and one or more blocks (or operations) of the process 1600 may be performed by one or more other components of other suitable devices, including the electronic device 104, the electronic device 110, and/or the electronic device 115. Further for explanatory purposes, some of the blocks of the process 1600 are described herein as occurring in serial, or linearly. However, multiple blocks of the process 1600 may occur in parallel. In addition, the blocks of the process 1600 need not be performed in the order shown and/or one or more blocks of the process 1600 need not be performed and/or can be replaced by other operations.

As illustrated in FIG. 16, at block 1602, an electronic device (e.g., electronic device 105) may obtain a two-dimensional image (e.g., two-dimensional image 800) containing multiple representations (e.g., cutout images 802, 804, and/or 806) of a multiple respective objects (e.g., objects 502, 504, and/or 506). Obtaining the two-dimensional image may include generating the two-dimensional image, or obtaining, from local or remote storage, a previously generated two-dimensional image. In one or more implementations, the two-dimensional image may be an atlas image.

At block 1604, the electronic device may obtain a mesh atlas (e.g., mesh atlas 1000) associated with the two-dimensional image. The mesh atlas and the two-dimensional image may be based on a representation (e.g., MSI representation 501, MPI representation 601, or another representation) of a three-dimensional scene (e.g., the three-dimensional scene of any of FIG. 3, 4, 5, 6, or 7). The representation of the three-dimensional scene may include multiple discrete layers (e.g., spherical layers such as layers 408, 410, 412, and 500, planar layers such as layers 600, 602, 604, and 606, or layers having other shapes and/or sizes) of scene content (e.g., objects 204, 214, 400, 402, 404, 406, 502, 504, and/or 506) that are spatially distributed across the three-dimensional scene (e.g., as illustrated in any of FIGS. 4-7). For example, the mesh atlas may include vertex information for each of the multiple respective objects. The vertex information for each of the multiple respective objects may include a set of vertices (e.g., vertices 910) corresponding to a boundary (e.g., boundary 960) of that object. For example, each of the multiple discrete layers of scene content may represent a respective depth in the three-dimensional scene. Obtaining the mesh atlas may include generating the mesh atlas, or obtaining, from local or remote storage, a previously generated mesh atlas. In one or more implementations, obtaining the mesh atlas may include obtaining the mesh atlas from metadata of the two-dimensional image.

At block 1606, the electronic device may obtain a viewpoint (e.g., viewpoint 510, 610, or 710) for viewing the three-dimensional scene. For example, obtaining the viewpoint may include determining a location of the electronic device and/or a user thereof, determining a pose of the electronic device and/or a user thereof, and/or determining a gaze location or direction of a user of the electronic device. For example, in a use case in which the electronic device is implemented as a head mountable device and the user is wearing the head mountable device, the viewpoint may change as the user moves their head and/or body, and/or looks around the three-dimensional (e.g., XR) scene.

At block 1608, the electronic device may render the three-dimensional scene from the viewpoint using the mesh atlas and the two-dimensional image. For example, the rendering may include identifying, using the mesh atlas, a portion of the two-dimensional image corresponding to an object in the three-dimensional scene; and rendering a portion of the three-dimensional scene by applying the portion of the two-dimensional image to a location in the three-dimensional scene, the location defined by the mesh atlas.

In one or more implementations, rendering the three-dimensional scene may include rendering, based on the mesh atlas, at least a subset of the multiple respective objects in an order from a nearest (e.g., to the electronic device or to a user of the electronic device) one of the subset of the multiple respective objects to a furthest (e.g., from the electronic device or to a user of the electronic device) one of the subset of the multiple respective objects.

In one or more implementations, the mesh atlas may include, for one of the multiple respective objects, a first coverage mesh (e.g., a portion 920) corresponding only to opaque pixels of the one of the plurality of respective objects, and a second coverage mesh (e.g., a portion 922) corresponding to a set of opaque pixels of the one of the multiple respective objects and to a set of transparent pixels outside a boundary (e.g., boundary 960) of the one of the multiple respective objects. In these implementations, the rendering may include rendering the one of the multiple respective objects by: rendering a first portion of the one of the multiple respective objects using depth testing based on the first coverage mesh; and rendering a second portion of the one of the multiple respective objects based on the second coverage mesh and without performing depth testing for the second portion of the one of the plurality of respective objects.

As described above, aspects of the subject technology may include the collection of data. The present disclosure contemplates that in some instances, this collected data may include personal information data that uniquely identifies or can be used to identify a specific person. Such personal information data can include demographic data, location-based data, online identifiers, telephone numbers, email addresses, home addresses data, image data, audio data, environment data, gaze data, image data, location data, pose data, or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for providing rendering using atlased coverage meshes from a particular viewpoint. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of providing rendering using atlased coverage meshes from a particular viewpoint, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 17 illustrates an example computing device with which aspects of the subject technology may be implemented in accordance with one or more implementations. The computing device 1700 can be, and/or can be a part of, any computing device or server for generating the features and processes described above, including but not limited to a laptop computer, a smartphone, a tablet device, a wearable device such as a goggles or glasses, and the like. The computing device 1700 may include various types of computer readable media and interfaces for various other types of computer readable media. The computing device 1700 includes a permanent storage device 1702, a system memory 1704 (and/or buffer), an input device interface 1706, an output device interface 1708, a bus 1710, a ROM 1712, one or more processing unit(s) 1714, one or more network interface(s) 1716, and/or subsets and variations thereof.

The bus 1710 collectively represents all system, peripheral, and chipset buses that communicatively connect the numerous internal devices of the computing device 1700. In one or more implementations, the bus 1710 communicatively connects the one or more processing unit(s) 1714 with the ROM 1712, the system memory 1704, and the permanent storage device 1702. From these various memory units, the one or more processing unit(s) 1714 retrieves instructions to execute and data to process in order to execute the processes of the subject disclosure. The one or more processing unit(s) 1714 can be a single processor or a multi-core processor in different implementations.

The ROM 1712 stores static data and instructions that are needed by the one or more processing unit(s) 1714 and other modules of the computing device 1700. The permanent storage device 1702, on the other hand, may be a read-and-write memory device. The permanent storage device 1702 may be a non-volatile memory unit that stores instructions and data even when the computing device 1700 is off. In one or more implementations, a mass-storage device (such as a magnetic or optical disk and its corresponding disk drive) may be used as the permanent storage device 1702.

In one or more implementations, a removable storage device (such as a flash drive, and its corresponding disk drive) may be used as the permanent storage device 1702. Like the permanent storage device 1702, the system memory 1704 may be a read-and-write memory device. However, unlike the permanent storage device 1702, the system memory 1704 may be a volatile read-and-write memory, such as random access memory. The system memory 1704 may store any of the instructions and data that one or more processing unit(s) 1714 may need at runtime. In one or more implementations, the processes of the subject disclosure are stored in the system memory 1704, the permanent storage device 1702, and/or the ROM 1712. From these various memory units, the one or more processing unit(s) 1714 retrieves instructions to execute and data to process in order to execute the processes of one or more implementations.

The bus 1710 also connects to the input and output device interfaces 1706 and 1708. The input device interface 1706 enables a user to communicate information and select commands to the computing device 1700. Input devices that may be used with the input device interface 1706 may include, for example, alphanumeric keyboards and pointing devices (also called “cursor control devices”). The output device interface 1708 may enable, for example, the display of images generated by computing device 1700. Output devices that may be used with the output device interface 1708 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 17, the bus 1710 also couples the computing device 1700 to one or more networks and/or to one or more network nodes through the one or more network interface(s) 1716. In this manner, the computing device 1700 can be a part of a network of computers (such as a LAN, a wide area network (“WAN”), or an Intranet, or a network of networks, such as the Internet. Any or all components of the computing device 1700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining a representation of a three-dimensional scene, the representation comprising a plurality of discrete layers of scene content that are spatially distributed across the three-dimensional scene;
generating, from the representation comprising the plurality of discrete layers and for a plurality of objects represented in the three-dimensional scene, one or more coverage meshes corresponding to the plurality of objects;
storing a mesh atlas, the mesh atlas comprising the one or more coverage meshes corresponding to the plurality of objects, in association with a two-dimensional image containing representations of the plurality of objects; and
providing the two-dimensional image and the mesh atlas for rendering of the three-dimensional scene.

2. The method of claim 1, wherein storing the mesh atlas comprises storing the mesh atlas as metadata for the two-dimensional image containing the representations of the plurality of objects.

3. The method of claim 1, wherein at least one of the one or more coverage meshes comprises vertex information for a boundary of one of the plurality of objects.

4. The method of claim 3, further comprising determining a number of vertices for the one of the plurality of objects by performing an optimization process based on candidate numbers of the vertices and a number of transparent pixels associated with the one of the plurality of objects.

5. The method of claim 4, wherein generating the at least one of the one or more coverage meshes comprises generating the vertex information for the boundary of the one of the plurality of objects by obtaining the vertex information for each of the determined number of vertices for the one of the plurality of objects.

6. The method of claim 1, wherein generating the one or more coverage meshes corresponding to the plurality of objects comprises:
generating the two-dimensional image containing the representations of the plurality of objects; and
generating the one or more coverage meshes corresponding to the plurality of objects based on the two-dimensional image.

7. The method of claim 1, wherein generating the one or more coverage meshes corresponding to the plurality of objects comprises generating the one or more coverage meshes corresponding to the plurality of objects based on the representation of the three-dimensional scene, and wherein the method further comprises generating the two-dimensional image based on the one or more coverage meshes corresponding to the plurality of objects and based on the representation of the three-dimensional scene.

8. The method of claim 1, wherein generating the one or more coverage meshes corresponding to the plurality of objects comprises:
generating, for a first one of the plurality of objects, a single respective coverage mesh corresponding to all pixels of the first one of the plurality of objects; and
generating, for a second one of the plurality of objects, first and second respective coverage meshes, wherein the first respective coverage mesh corresponds to only opaque pixels of the second one of the plurality of objects, and wherein the second respective coverage mesh corresponds to a set of opaque pixels of the second one of the plurality of objects and to a set of transparent pixels outside a boundary of the second one of the plurality of objects.

9. The method of claim 1, wherein each of the plurality of discrete layers of scene content represent a respective depth in the three-dimensional scene.

10. The method of claim 9, wherein each of the plurality of discrete layers comprises a spherical layer.

11. The method of claim 9, wherein each of the plurality of discrete layers comprises a planar layer.

12. A method, comprising:
obtaining, by an electronic device, a two-dimensional image containing a plurality of representations of a plurality of respective objects;
obtaining a mesh atlas associated with the two-dimensional image, wherein the mesh atlas and the two-dimensional image are based on a representation of a three-dimensional scene, the representation of the three-dimensional scene comprising a plurality of discrete layers of scene content that are spatially distributed across the three-dimensional scene;
obtaining a viewpoint for viewing the three-dimensional scene; and
rendering the three-dimensional scene from the viewpoint using the mesh atlas and the two-dimensional image.

13. The method of claim 12, wherein the rendering comprises:
identifying, using the mesh atlas, a portion of the two-dimensional image corresponding to an object in the three-dimensional scene; and
rendering a portion of the three-dimensional scene by applying the portion of the two-dimensional image to a location in the three-dimensional scene, the location defined by the mesh atlas.

14. The method of claim 12, wherein rendering the three-dimensional scene comprising rendering, based on the mesh atlas, at least a subset of the plurality of respective objects in an order from a nearest one of the subset of the plurality of respective objects to a furthest one of the subset of the plurality of respective objects.

15. The method of claim 12, wherein the mesh atlas comprises vertex information for each of the plurality of respective objects.

16. The method of claim 15, wherein the vertex information for each of the plurality of respective objects comprises a set of vertices corresponding to a boundary of that object.

17. The method of claim 12, wherein the mesh atlas comprises, for one of the plurality of respective objects:
a first coverage mesh corresponding only to opaque pixels of the one of the plurality of respective objects; and
a second coverage mesh corresponding to a set of opaque pixels of the one of the plurality of respective objects and to a set of transparent pixels outside a boundary of the one of the plurality of respective objects.

18. The method of claim 17, wherein the rendering comprises:
rendering the one of the plurality of respective objects by:
rendering a first portion of the one of the plurality of respective objects by reading and writing depth information during depth testing based on the first coverage mesh; and
rendering a second portion of the one of the plurality of respective objects based on the second coverage mesh and without writing depth information during depth testing for the second portion of the one of the plurality of respective objects.

19. The method of claim 12, wherein each of the plurality of discrete layers of scene content represent a respective depth in the three-dimensional scene.

20. An electronic device, comprising:
a memory; and
one or more processors configured to:
obtain a two-dimensional image containing a plurality of representations of a plurality of respective objects;
obtain a mesh atlas associated with the two-dimensional image, wherein the mesh atlas and the two-dimensional image are based on a representation of a three-dimensional scene, the representation of the three-dimensional scene comprising a plurality of discrete layers of scene content that are spatially distributed across the three-dimensional scene;
obtain a viewpoint for viewing the three-dimensional scene; and
render the three-dimensional scene from the viewpoint using the mesh atlas and the two-dimensional image.
